(19) United States
(12) Patent Application Publication
(10) Pub. No.: US 2014/0184650 A1
(43) Pub. Date: Jul. 3, 2014

(54) INFORMATION PROCESSING DEVICE, DISPLAY METHOD AND COMPUTER PROGRAM PRODUCT

(71) Applicant: Kabushiki Kaisha Toshiba, Tokyo (JP)

(72) Inventors: Koji Hachiya, Tokyo (JP); Natsumi Endo, Kanagawa (JP)

(73) Assignee: Kabushiki Kaisha Toshiba, Tokyo (JP)

(21) Appl. No.: 14/018,660

(22) Filed: Sep. 5, 2013

Related U.S. Application Data
(63) Continuation of application No. PCT/JP2013/058408, filed on Mar. 22, 2013.

(30) Foreign Application Priority Data
Dec. 27, 2012 (JP) 2012-286297

(51) Int. Cl. G06T 3/40

(52) U.S. Cl. CPC G06T 3/40
USPC 345/660

(57) ABSTRACT

According to one embodiment, an information processing device includes an input controller, a display controller, a setting module and an executing module. The display controller is configured to display characters with an enlargement ratio based on a use method on a display unit. The setting module is configured to perform a setting based on the use method. The executing module is configured to execute a related tool based on the use method.

### CROSS-REFERENCE TO RELATED APPLICATIONS

This application is a continuation of PCT international application Ser. No. PCT/JP2013/058408 filed on Mar. 22, 2013 which designates the United States, incorporated herein by reference, and which claims the benefit of priority from Japanese Patent Application No. 2012-286297, filed on Dec. 27, 2012, the entire contents of which are incorporated herein by reference.

### FIELD

Embodiments described herein relate generally to an information processing device, a display method, and a computer program.

### BACKGROUND

Recently personal computers (PCs) having a high-density, high-definition display exceeding DPI200 have made their debut, and 4K2K (3840×2160 dots) panels have been supported by PCs. Such a high-density, high-definition display has various display use methods such as a use method that gives a higher priority to the amount of information by displaying characters in a smaller size and a use method that gives a higher priority to viewability by displaying characters in a larger size, which offers users a wide range of options.

However, even when a user selects a desired use method from various display use methods, such a conventional technology has difficulties in setting various settings or the like corresponding to the selected use method in a PC or the like.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram illustrating the appearance of a computer according to an embodiment;

FIG. 2 is an exemplary block diagram illustrating schematically the configuration of the computer in the embodiment;

FIG. 3 is an exemplary block diagram illustrating part of a functional configuration of the computer in the embodiment;

FIGS. 4A, 4B, and 4C are exemplary diagrams illustrating an example of setting data for each use method of the embodiment;

FIG. 5 is an exemplary diagram for describing a change in the travel speed of a mouse pointer in the embodiment;

FIG. 6 is an exemplary flowchart illustrating the procedure of display processing of the embodiment;

FIG. 7 is an exemplary diagram illustrating an example of a use method selection screen of the embodiment;

FIG. 8 is an exemplary diagram illustrating an example of a confirmation screen of the embodiment;

FIG. 9 is an exemplary diagram illustrating an example of a recommendation screen of a screen splitting tool of the embodiment;

FIG. 10 is an exemplary diagram illustrating an example of a recommendation screen of an enlargement tool of the embodiment;

FIG. 11 is an exemplary diagram illustrating an example of screen display of an efficiency-oriented case of the embodiment;

FIG. 12 is an exemplary diagram illustrating an example of the screen display of an efficiency-oriented case of the embodiment; and

FIG. 13 is an exemplary diagram illustrating an example of a customizing screen of the embodiment.

### DETAILED DESCRIPTION

In general, according to one embodiment, an information processing device comprises an input controller, a display controller, a setting module and an executing module. The input controller is configured to receive inputting of a use method of the information processing device from a user. The display controller is configured to display characters with an enlargement ratio based on the use method on a display unit. The setting module is configured to perform a setting based on the use method. The executing module is configured to execute a related tool based on the use method.

The embodiment describes an example in which an information processing device, a method, and a computer program product are applied to a notebook personal computer 10 (hereinafter, the computer). However, it is not a limited example, and they can also be applied to, for example, a remote controller, a television receiver, and a hard disk recorder.

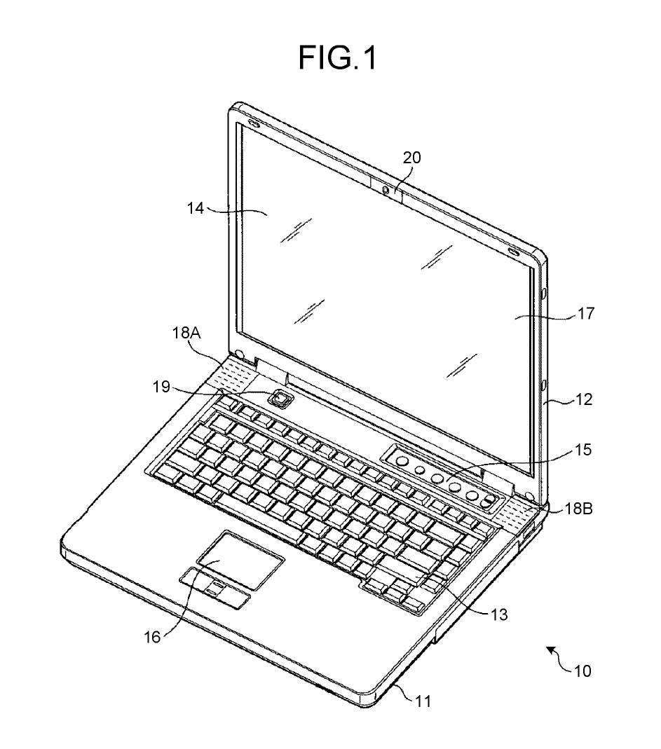

As illustrated in FIG. 1, this computer 10 according to the embodiment comprises a body 11 and a display unit 12. Installed in the display unit 12 is a display device having a liquid crystal display (LCD) 17. Also installed in the display unit 12 is a touch panel 14 that covers the surface of the LCD 17. The display unit 12 is attached to the body 11 in a pivotable manner and allowed to be positioned between an open position in which the upper surface of the body 11 is exposed and a closed position in which the upper surface of the body 11 is covered. The display unit 12 includes a camera module 20 at the top of the LCD 17. The camera module 20 is used for capturing an image of an operator of the computer 10 or the like when the display unit 12 is in the open position that exposes the upper surface of the body 11.

The body 11 comprises a thin, box-shaped casing, and arranged on its upper surface are a keyboard 13, an input control panel 15, a touch pad 16, speakers 18A and 18B, a power button 19 for turning the power of the computer 10 on or off, for example. Various operational buttons are provided on the input control panel 15.

Provided on the back of the body 11 is an external display connection terminal (not illustrated) that is compliant with, for example, the high-definition multimedia interface (HDMI). This external display connection terminal is used for outputting a digital video signal to an external display.

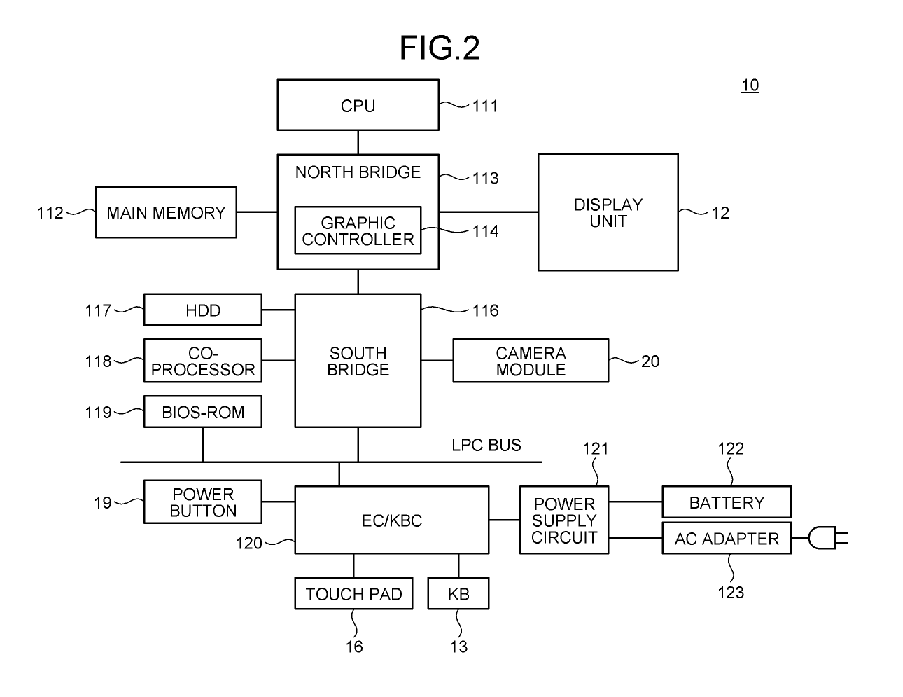

The computer 10 according to the embodiment comprises, as illustrated in FIG. 2, a central processing unit (CPU) 111, a main memory 112, a north bridge 113, a graphic controller 114, the display unit 12, a south bridge 116, a hard disk drive (HDD) 117, a co-processor 118, a basic input/output system -read only memory (BIOS-ROM) 119, an embedded controller/keyboard controller (EC/KBC) 120, a power supply circuit 121, a battery 122, an AC adapter 123, the touch pad 16, the keyboard (KB) 13, the camera module 20, and the power button 19.

The CPU 111 is a processor that controls the operation of the computer 10. The CPU 111 executes an operating system (OS) and various application programs that are loaded from the HDD 117 into the main memory 112. The CPU 111 also executes the BIOS stored in the BIOS-ROM 119. The BIOS is a program for controlling peripheral devices. The BIOS is executed first when the power of the computer 10 is turned on.

The north bridge 113 is a bridge device that connects a local bus of the CPU 111 and the south bridge 116. The north bridge 113 has a function of executing communications with the graphic controller 114 through an accelerated graphics port (AGP) or the like.

The graphic controller 114 is a display controller that controls the display unit 12 of the computer 10. The graphic controller 114 generates a display signal to be output to the display unit 12 from display data written in a video random access memory (VRAM) (not illustrated) by the OS or application programs.

Connected to the south bridge 116 are the HDD 117, the co-processor 118, the BIOS-ROM 119, the camera module 20, and the EC/KBC 120. The south bridge 116 comprises an integrated drive electronics (IDE) controller for controlling the HDD 117 and the co-processor 118.

The EC/KBC 120 is a one-chip microcomputer that integrates an embedded controller (EC) for power control and a keyboard controller (KBC) for controlling the touch pad 16 and the keyboard (KB) 13. The EC/KBC 120 turns the power of the computer 10 on in cooperation with the power supply circuit 121 when, for example, the power button 19 is operated. When external power is supplied through the AC adapter 123, the computer 10 is driven by the external power. When no external power is supplied, the computer 10 is driven by the battery 122.

The camera module 20 is, for example, a universal serial bus (USB) camera such as a Web camera. A USB connector of the camera module 20 is connected to a USB port (not illustrated) provided on the body 11 of the computer 10.

The co-processor 118 performs processing on moving image data acquired from the camera module 20 or the like.

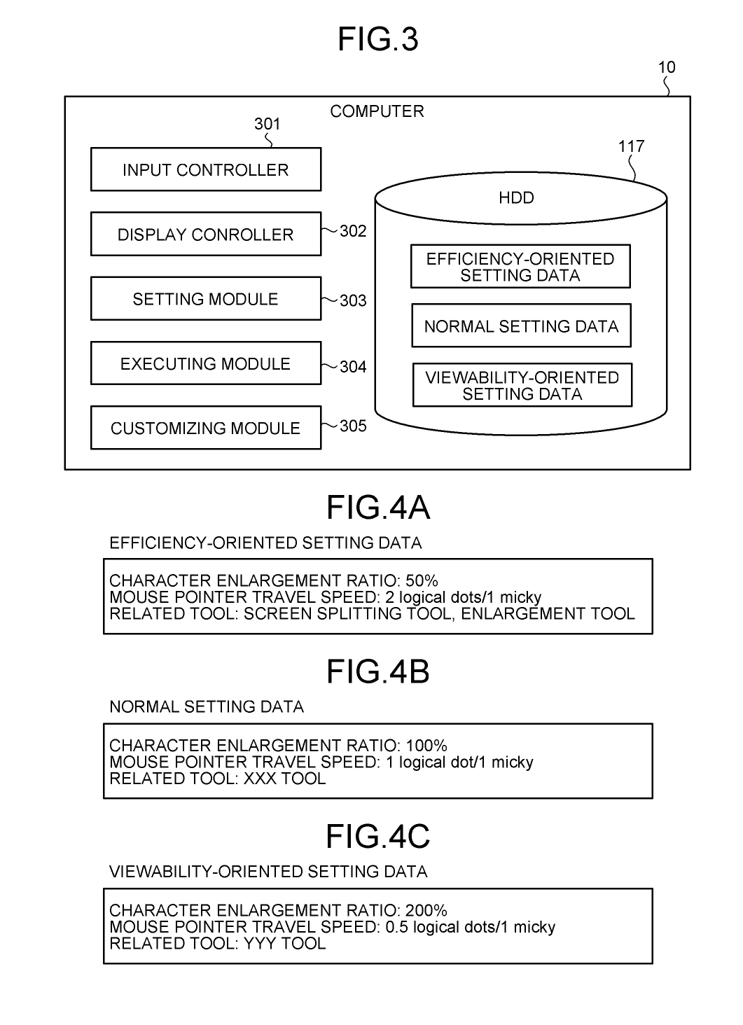

The computer 10 according to the embodiment comprises, as its functional configuration, as illustrated in FIG. 3, an input controller 301, a display controller 302, a setting module 303, an executing module 304, a customizing module 305, and the HDD 117.

In an operating system in general, with respect to the character size, 96 DPI (dot per inch) is taken as a basic size. This size means that when display is performed on a display unit with a dot density of 96 DPI, 96 dots correspond to 1 inch. When a character with a width of 9.6 dots is displayed, it is represented in 0.1 inch.

When display is performed on a display unit with, for example, 192 DPI, which is simply double the density, 96 dots correspond to 0.5 inches. A character with a width of 9.6 dots is then represented in 0.05 inches, leading to relatively small characters on the screen, which makes it hard for a user to view them.

To deal with this situation, the operating system can set a highly viewable state by enlarging the basic size of the character size. In this case, when 192 DPI, which is double, is set as the basic size as internal representation within the operating system, a character with a width of 9.6 dots is represented in 0.1 inches. In the embodiment, a character enlargement ratio means an enlargement ratio with respect to the basic size of the character size. The character enlargement ratio is represented as 150% (144 DPI) and 200% (196 DPI) with 96 DPI set as 100% generally on the operating system.

When the character enlargement ratio is changed, as the size is increased, the viewability of a character itself increases, but the amount of information displayed on a display screen at a time decreases. Conversely, as the character size is decreased, the amount of information increases, but the viewability decreases. This means namely that a plurality of use environments can be prepared on one display screen, which is conventionally unable to be achieved with a low-density display.

For example, it is possible to “read characters in a easily viewable manner, because display is performed in the same character size as the conventional one in appearance, but the amount of information for one character increases” and, it is also possible to “make characters readable and increase the amount of information displayed at a time, because the display is performed in a smaller character size than the conventional one in appearance, but the character is not unreadable even with the smaller size.” Increased density leads to more use applications than ever before.

However, operability may degrade merely by changing the character size. The character enlargement ratio is changed by a user in accordance with a use method, and the user may wish, after changing the character enlargement ratio, to perform other screen settings and the setting of related tools such as software. It is difficult for conventional technologies to easily perform such settings and the setting of tools or the like.

To deal with these circumstances, the embodiment allows a user to input a use method of a computer, performs display with a character enlargement ratio corresponding to the input use method, and performs settings and the start-up and settings of related tools corresponding to the enlargement ratio based on the input use method, thereby easily achieving various settings in accordance with the desired use method by the user to obtain a comfortable environment. The following describes a configuration therefor in detail.

In FIG. 3, the input controller 301 receives the inputting of a use method of the computer from the user. Specifically, the input controller 301 receives selection by the user through a use method selection screen that allows desired selection out of an efficiency-oriented use method, a normal use method, and a viewability-oriented use method.

The display controller 302 displays characters with an enlargement ratio based on the use method of which the inputting has been received by the input controller 301 on the display unit 12. Specifically, the display controller 302 reads setting data described below corresponding to the selected use method from the HDD 117, identifies an enlargement ratio registered in the setting data of the use method, and displays characters with the identified enlargement ratio on the display unit 12. The display of characters with the identified enlargement ratio is achieved by, for example, but not limited to, the issue of a system call of an application programming interface (API) provided by the OS.

The normal use method is a setting having balance between work efficiency and viewability, in which the display controller 302 performs display with a standard character enlargement ratio. The viewability-oriented use method is suitable for browsing the Web, an electronic book, or the like, in which the display controller 302 uses an enlargement ratio that is higher than the normal one. The efficiency-oriented use method is suitable for performing work on a plurality of applications simultaneously, in which the display controller 302 performs display with an enlargement ratio that is lower than the normal one.

The setting module 303 reads the setting data of the input use method and performs the setting of the travel speed of a mouse pointer based on the use method in accordance with the setting data. The setting module 303 also changes window display settings such as a title bar and a button size of a window in accordance with the enlargement ratio. The setting module 303 may be configured so that settings other than those are changed. The setting of the travel speed of the mouse pointer and various settings are achieved by the issue of a system call of the API provided by the OS, but not limited thereto.

The executing module 304 reads the setting data of the input use method from the HDD 117 and executes a related tool based on the use method in accordance with the setting data.

Stored in the HDD 117 are setting data for each use method, that is, efficiency-oriented setting data, normal setting data, and viewability-oriented setting data. Registered in each setting data are a character enlargement ratio corresponding to each use method, the travel speed of the mouse pointer, and a related tool.

In an example of setting data for each use method illustrated in FIGS. 4A to 4C, FIG. 4A illustrates the efficiency-oriented setting data, FIG. 4B illustrates the normal setting data, and FIG. 4C illustrates the viewability-oriented setting data. As illustrated in FIGS. 4A to 4C, with respect to the setting data, the enlargement ratio is set so that it descends in the order of viewability-oriented, normal, and efficiency-oriented. The display controller 302 then displays characters on the display unit 12 with the highest enlargement ratio, the enlargement ratio of the second largest size, and the enlargement ratio of the third largest size, when the input use method is the viewability-oriented use method, the normal use method, and the efficiency-oriented use method, respectively.

When the character enlargement ratio is changed in accordance with the use method, a logical dot and a physical dot are equal with the enlargement ratio being 100%, and in contrast, for example, the logical dot is double the physical dot with the enlargement ratio being 200%. This relation between the logical dot and the physical dot is influenced by not only the character size but also, for example, the travel speed of the mouse pointer.

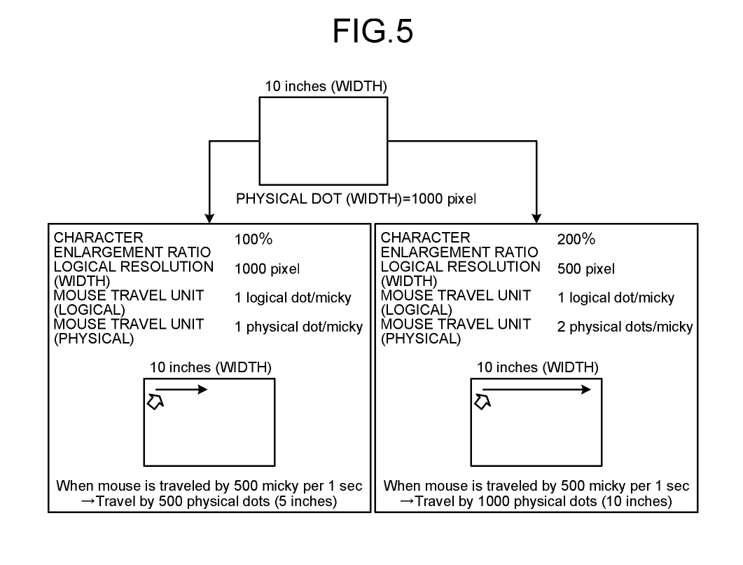

For example, when the enlargement ratio is 100%, under a setting that 1 logical dot corresponds to a travel distance of the mouse pointer on the display screen of 1 micky ( 1/100 inches), the movement of the mouse pointer on the display screen by 1 micky as an actual operation results in movement by 1 physical dot. In this situation, when the character enlargement ratio is set to 200%, the setting that the travel speed of the mouse pointer is 1 logical dot with respect to 1 micky is not changed, but 1 logical dot is changed to 2 physical dots. For this reason, when the mouse pointer is traveled by 1 micky, it travels 2 physical dots, as illustrated in FIG. 5.

In this case, therefore, the travel speed of the mouse pointer with an enlargement ratio of 200% is double the travel speed of the mouse pointer when the enlargement ratio is 100%. For this reason, the user may feel that the travel speed of the mouse pointer is too high as an operational feeling with respect to the same display screen size.

Such a change in the operational feeling about the mouse along with a change in the character enlargement ratio may affect an operational feeling about image editing software or the like in particular. The image editing software or the like generally handles internal data by the physical dot in order to make full use of high resolution and high density. When the travel speed of the mouse changes in such software, it is difficult to edit an image and draw a picture with the same feeling because the character enlargement ratio has been changed.

Therefore, when display is performed with the character enlargement ratio changed, the embodiment also changes the travel speed of the mouse pointer through the setting module 303.

Specifically, as illustrated in FIGS. 4A to 4C, in the setting data, the travel speed of the mouse pointer is set so that it descends in the order of the viewability-oriented method, the normal method, and the efficiency-oriented method, that is, in descending order of enlargement ratio. Therefore, the display controller 302 sets the travel speed of the mouse pointer so that it descends in accordance with the order of the input use method, namely, the viewability-oriented use method, the normal use method, and the efficiency-oriented use method (in descending order of enlargement ratio). In the setting data of the example of FIGS. 4A to 4C, in accordance with the above-described example using FIG. 5, the setting module 303 sets the travel speed of the mouse pointer to 0.5 logical dots/1 micky when the character enlargement ratio is 200%. In the setting data of the example of FIGS. 4A to 4C, when the character enlargement ratio is 100% and 50%, the travel speed of the mouse pointer is set to 1 logical dot/1 micky and 2 logical dots/1 micky, respectively.

When the character enlargement ratio is low in accordance with the use method, the amount of information represented on the display screen increases, thereby allowing the user to read sufficient information in each of a plurality of windows arranged on the display screen. When the character enlargement ratio is low, therefore, splitting the screen into small fractions by screen splitting software allows the user to make effective use of a wide screen and handle a plurality of applications at a time.

In contrast, when the character enlargement ratio is higher, the amount of information displayed on the display screen decreases, thereby making it difficult for a user to read sufficient information even with a plurality of windows open on the screen. Therefore, the user inevitably performs work with a single window or a fewer number of windows open. When the character enlargement ratio is thus high, splitting by a screen splitting tool is not useful. The embodiment determines whether to use the screen splitting tool in accordance with the enlargement ratio.

Conventionally, when the character enlargement ratio is changed, a user himself/herself is required to change a related software function manually, which is troublesome. With respect to also settings and related tools, which are influenced by the enlargement ratio and have influence on user's operational feeling and a use environment, the embodiment performs settings in accordance with a change in the enlargement ratio, thereby allowing the user to obtain a comfortable use environment corresponding to each character enlargement ratio.

Specifically, as illustrated in FIGS. 4A to 4C, a related tool is set in the setting data. In the example of FIGS. 4A to 4C, when the input use method is the efficiency-oriented use method, the executing module 304 executes a tool that performs display with the display screen split. When the input use method is the efficiency-oriented use method, the executing module 304 executes a tool that displays the characters on the display screen in an enlarged manner.

The customizing module 305 customizes an enlargement ratio, a setting, and a related tool based on a use method by changing the setting data corresponding to each use method in accordance with an instruction from the user.

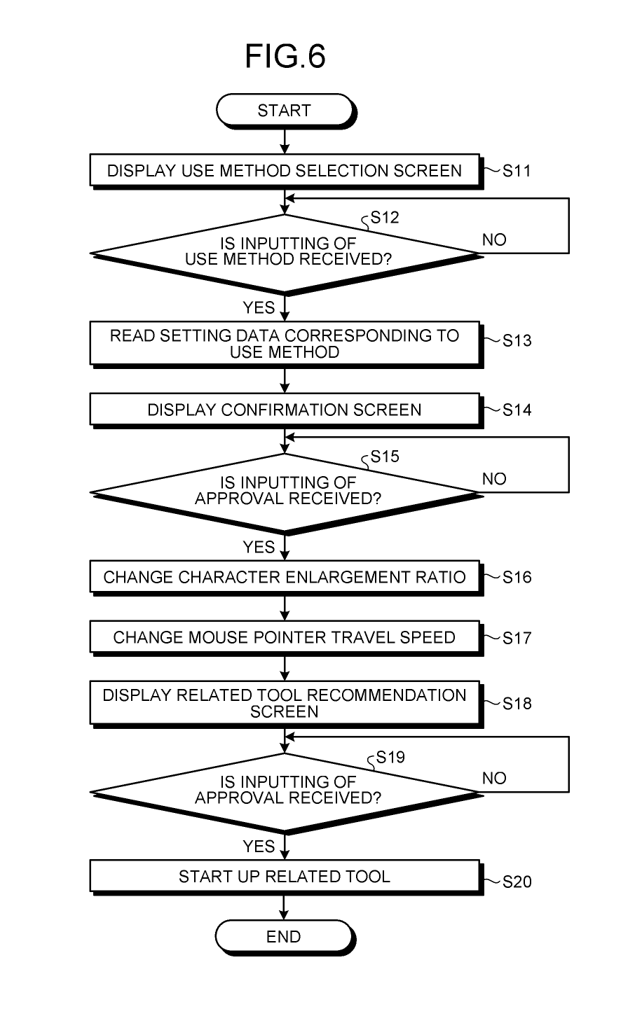

Described next using FIG. 6 is display processing by the computer 10 of the embodiment configured as above. The following processing is executed by starting up a display processing application from a desktop screen of Windows (registered trademark) or the like, but its execution timing is not limited thereto.

First, the display controller 302 displays a use method selection screen on the display unit 12 (S11) to be in a state waiting for receiving the inputting of a use method by a user from the use method selection screen (S12).

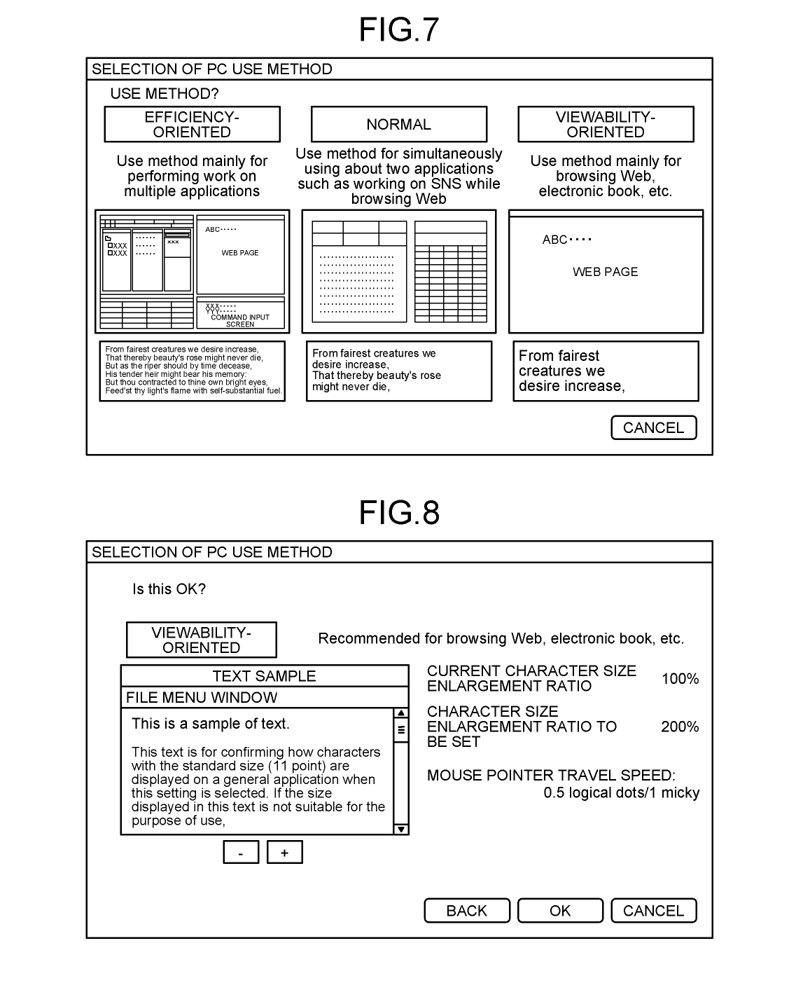

As illustrated in FIG. 7, the use method selection screen shows an example of a character size depending on a character enlargement ratio and an example of a display use of an application in accordance with the use method. When the user selects a box displaying a desired use method on this screen, the inputting of the use method is received by the input controller 301.

Returning to FIG. 6, if the inputting of the use method is received (S12), the display controller 302 reads the setting data corresponding to the input use method from the HDD 117 (S13). The display controller 302 then, in accordance with the contents of the read setting data, displays an enlargement ratio based on the use method and a confirmation screen for the setting on the display unit 12 (S14).

Displayed on the confirmation screen are, as illustrated in FIG. 8, in addition to the use method input by the user (“viewability-oriented” in the example of FIG. 8), the enlargement ratio and the travel speed of the mouse pointer, which are the contents registered in the setting data read at S13. Also displayed are a recommended use application of the use method and a sample of characters with a size corresponding to the enlargement ratio. Through this confirmation screen, the user presses the OK button to give approval to display by this use method and presses the cancel button not to display by this use method.

Returning to FIG. 6, if the user presses the OK button and the input controller 301 receives the approval of displaying by the input use method (Yes at S15), the display controller 302 changes the character enlargement ratio in accordance with the setting data (S16).

Next, the setting module 303 changes the travel speed of the mouse pointer in accordance with the setting data (S17). The setting module 303 also changes window display settings or the like such as a title bar and a button size of a window.

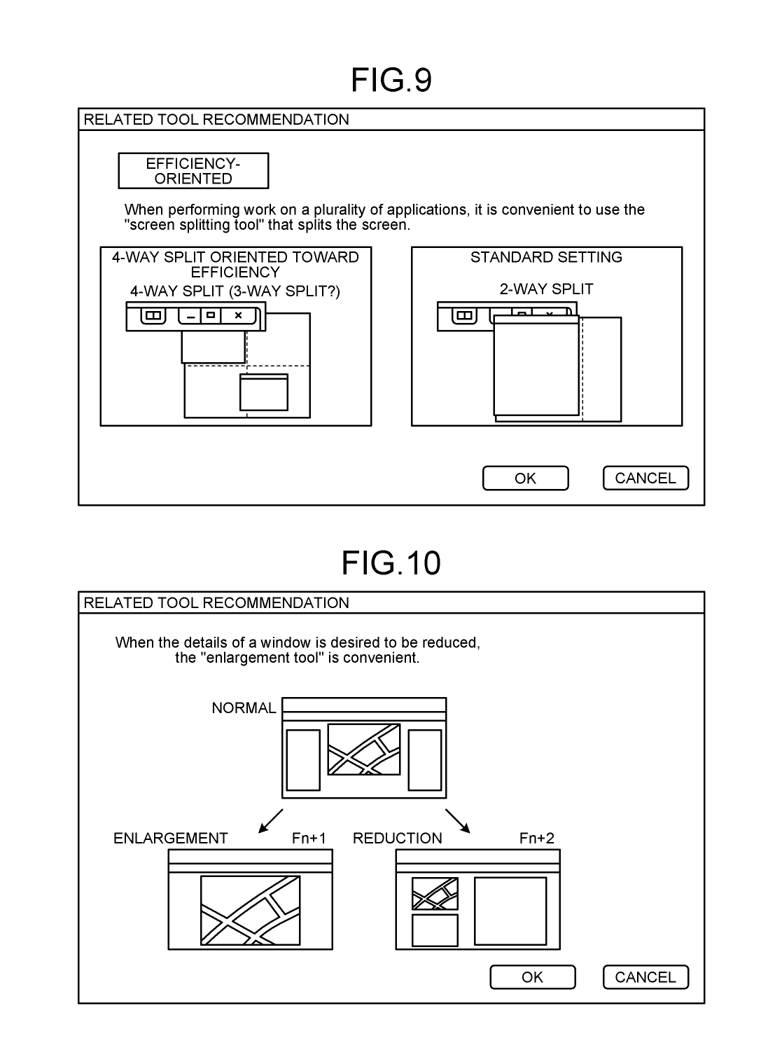

Next, the display controller 302 displays a recommendation screen for a related tool registered in the setting data of the input use method on the display unit 12 (S18). When the use method is efficiency-oriented, a recommendation screen for a screen splitting tool registered in the efficiency-oriented setting data is displayed as the related tool as illustrated in FIG. 9. When the use method is efficiency-oriented, a recommendation screen for an enlargement tool registered in the efficiency-oriented setting data is displayed as the related tool as illustrated in FIG. 10.

In the recommendation screen of the example of FIG. 9, the number of splits of the screen can be selected. In the example of FIG. 10, key operation for enlargement is also displayed.

The user presses the OK button on the recommendation screen to use the related tool recommended on the recommendation screen and presses the cancel button not to use the related tool.

Returning to FIG. 6, if the input controller 301 receives the approval of the related tool (Yes at S19), the executing module 304 starts up the related tool (S20). The display controller 302 displays a screen with a character size with an enlargement ratio that has been changed in accordance with the use method on the display unit 12.

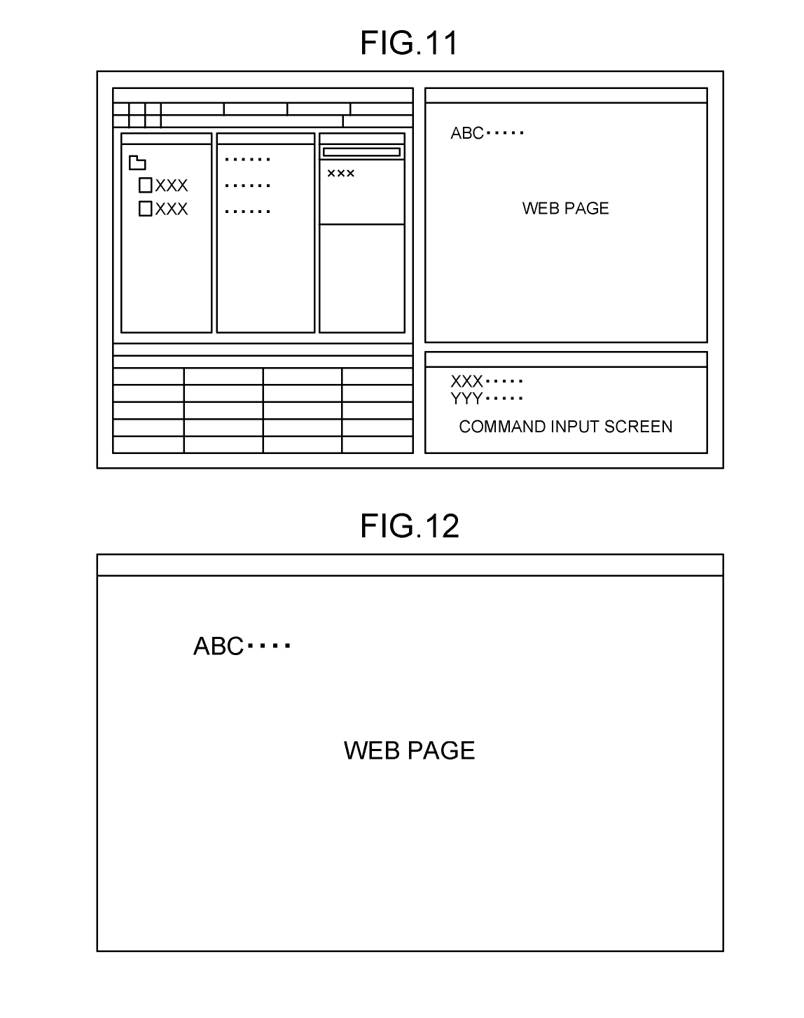

A screen display example when the use method is efficiency-oriented is illustrated in FIG. 11, and a screen display example when the use method is viewability-oriented is illustrated in FIG. 12. The efficiency-oriented screen display illustrated in FIG. 11 has a larger amount of information than the viewability-oriented screen display illustrated in FIG. 11 has. Although the screen of FIG. 12 has a smaller amount of information than the efficiency-oriented screen display illustrated in FIG. 11 has, a larger character size and a fewer number of windows provide viewability.

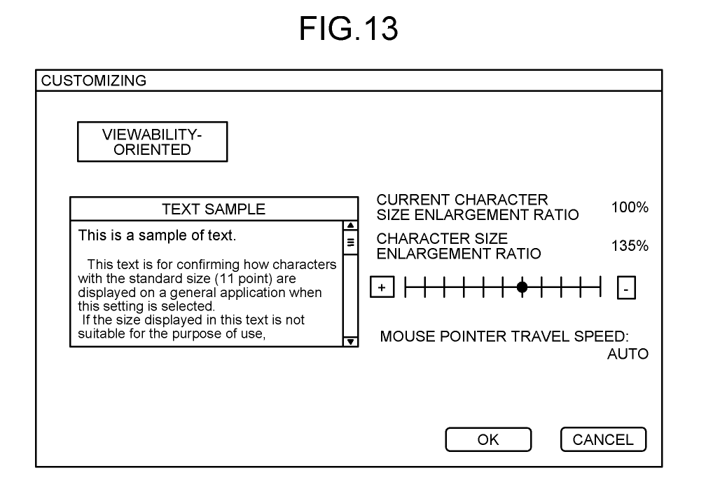

When the user changes the setting data in the HDD 117 to customize its setting contents, an enlargement ratio, the travel speed of the mouse pointer, and a related tool are set through a customization screen illustrated in FIG. 13, and the settings are received by the input controller 301. The customizing module 305 then updates each setting data in the HDD 117 based on the received setting contents.

When the user inputs a use method, the embodiment thus determines an enlargement ratio corresponding to the use method and allows confirmation of a character size in the enlargement ratio on the confirmation screen, thereby easily achieving a setting corresponding to the desired use method without care on the character enlargement ratio.

Once the enlargement ratio is determined in accordance with the use method, the embodiment performs other settings and the setting of a related tool corresponding to the use method and the enlargement ratio, thereby eliminating the need to manually perform various settings and the start-up and setting of the related tool and allowing the user to easily achieve various settings and the start-up and setting of the related tool along with a change in the enlargement ratio corresponding to the use method and obtain a comfortable environment. In particular, the embodiment also determines the travel speed of the mouse pointer in accordance with the character enlargement ratio, thereby eliminating the need for the user to manually perform the setting operation of the mouse pointer and achieving a simpler operation.

The embodiment can provide the user with a comfortable use environment suitable for the environment of each use method only by allowing the user to input the use method of the computer and perform a simple procedure.

A display processing program to be executed on the computer 10 of the embodiment is recorded in a computer-readable recording medium such as the HDD 117, a CD-ROM, a flexible disk (FD), a CD-R, and a digital versatile disk (DVD) as a file in an installable format or an executable format to be provided as a computer program product.

The display processing program to be executed on the computer 10 of the embodiment may be configured so that it is stored in a computer connected to a network such as the Internet and is downloaded through the network to be provided. The display processing program to be executed on the computer 10 of the embodiment may be provided or distributed through a network such as the Internet.

The display processing program to be executed on the computer 10 of the embodiment may be configured so that it is incorporated into a ROM or the like in advance to be provided.

The display processing program to be executed on the computer 10 of the embodiment is modularly-configured so as to include the above-mentioned modules (the input controller 301, the display controller 302, the setting module 303, the executing module 304, and the customizing module 305). As actual hardware, the CPU 111 reads the display processing program from the above-mentioned storage medium such as the HDD 117 and executes it, thereby allowing the above-mentioned modules to be loaded into the main memory 112 and allowing the input controller 301, the display controller 302, the setting module 303, the executing module 304, and the customizing module 305 to be generated on the main memory 112.

The present invention is not limited to the above-mentioned embodiment as it is and can be embodied with the components modified without departing from the scope of the invention at an implementation phase. An appropriate combination of a plurality of components disclosed in the above-mentioned embodiment can form various inventions. For example, some components may be deleted from the entire components disclosed in the embodiment. Furthermore, components across different embodiments may be appropriately combined.

Examples of such a modification include the following. Although the embodiment performs the inputting of a use method, the confirmation and setting of an enlargement ratio, and the start-up and setting of a related tool through an interactive interface with a user, it is not a limited example. For example, it may be configured so that various settings and the start-up and setting of the related tool or the like are achieved only by setting input through a single window without using an interactive interface, without displaying the confirmation screen for the enlargement ratio and the recommendation screen for the related tool.

Although the embodiment performs the settings of the travel speed of the mouse pointer and the user interface along with a change in the enlargement ratio, they are not limited examples. For example, the setting module 303 may be configured so as to change settings such as a window size suitable fora touch panel, font smoothing, screen resolution, a screen display state (multi-monitor or single monitor), and a screen color, as screen-related items, on the basis of an input use method.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
an input controller configured to receive inputting of a use method of the information processing device from a user;
a display controller configured to display characters with an enlargement ratio based on the use method on a display unit;
a setting module configured to perform a setting based on the use method; and
an executing module configured to execute a related tool based on the use method.

2. The information processing device of claim 1, wherein the display controller is configured to display a display state with the enlargement ratio based on the use method on the display unit, and when receiving an instruction to perform display with the display state from a user, display characters with the enlargement ratio on the display unit.

3. The information processing device of claim 1, wherein the display controller is configured to display a message that a related tool based on the use method is recommended on the display unit.

4. The information processing device of claim 1, wherein
the use method includes an efficiency-oriented use method, a normal use method, and a viewability-oriented use method,
the input controller is configured to receive inputting of one of the viewability-oriented use method, the normal use method, and the efficiency-oriented use method by the user, and
the display controller is configured to display the characters on the display unit with the enlargement ratio that descends in accordance with the order of the viewability-oriented use method, the normal use method, and the efficiency-oriented use method.

5. The information processing device of claim 4, wherein the setting module is configured to set a travel speed of a mouse pointer on a display screen so that the travel speed descends in accordance with the order of the viewability-oriented use method, the normal use method, and the efficiency-oriented use method.

6. The information processing device of claim 4, wherein the executing module is configured to execute a tool that performs display with a display screen split when the input use method is the efficiency-oriented use method.

7. The information processing device of claim 4, wherein the executing module is configured to execute a tool that displays characters on a display screen in an enlarged manner when the input use method is the efficiency-oriented use method.

8. The information processing device of claim 1, further comprising a customizing module configured to customize the enlargement ratio, the setting, and the related tool based on the use method.

9. A display method comprising:
receiving inputting of a display use method by a display unit from a user;
displaying characters on the display unit with an enlargement ratio based on the display use method;
performing a setting based on the display use method; and
executing a related tool based on the display use method.

10. A computer program product having a non-transitory computer readable medium including programmed instructions, wherein the instructions, when executed by a computer, cause the computer to perform:
receiving inputting of a display use method by a display unit from a user;
displaying characters on the display unit with an enlargement ratio based on the display use method;
performing a setting based on the display use method; and
executing a related tool based on the display use method.
